(19) United States
(12) Patent Application Publication
(10) Pub. No.: US 2012/0242701 A1
(43) Pub. Date: Sep. 27, 2012

(54) ACCESSORY DEPENDENT DISPLAY ORIENTATION

(75) Inventor: Michael I. Ingrassia, JR., Cupertino, CA (US)

(73) Assignee: APPLE INC., Cupertino, CA (US)

(21) Appl. No.: 13/072,570

(22) Filed: Mar. 25, 2011

(51) Int. Cl. G09G 5/00

(52) U.S. Cl. 345/649

(57) ABSTRACT

Systems and methods are provided for orienting a display of a user device display screen. A user device may be coupled to an accessory, and the display orientation of the user device may be managed. The display orientation may be determined based on a type of the accessory, accessory identification information, a supported communications protocol, output of an accelerometer, user information, or other information. Criteria may be stored, from which a criterion for orienting the display may be selected based on available information.

The present disclosure is directed towards orienting a display of a user device. More particularly, the present disclosure is directed, in some embodiments, towards orienting a display of a user device coupled to an accessory based on information about the accessory.

### BACKGROUND

A user device such as a smart phone or personal media player may be coupled to an accessory, which may allow for communication, charging, or both between the user device and the accessory. For example, a mobile phone may be charged by plugging a wall charger into a port of the phone. There may exist a variety of accessories and accessory types, which may serve a variety of functions.

The display orientation of a user device is usually set according to manual user input, or according to an accelerometer. Display orientation, however, is agnostic with respect to whether the device is coupled or with respect to the type of accessory the device is coupled.

### SUMMARY

This disclosure relates to systems and methods for orienting a display of a user device display screen. Processing equipment may determine that a user device is coupled to an accessory. The processing equipment may determine a display orientation based at least in part on information about the accessory such as, for example, the accessory type. The display of the user device may be oriented according to the determined display orientation.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows a front elevation view of an illustrative user device in accordance with some embodiments of the present disclosure;

FIG. 2 shows a front elevation view of the illustrative user device of FIG. 1 having a different display orientation in accordance with some embodiments of the present disclosure;

FIG. 3 shows a front elevation view of the illustrative user device of FIG. 2 but having a different display orientation in accordance with some embodiments of the present disclosure;

FIG. 4 shows an illustrative docking arrangement between a user device and a stationary accessory in accordance with some embodiments of the present disclosure;

FIG. 5 shows an illustrative docking arrangement between a user device and a dynamic accessory in accordance with some embodiments of the present disclosure;

FIG. 6 shows an illustrative docking arrangement between a user device and an adjustable accessory in accordance with some embodiments of the present disclosure;

FIG. 7A is a flow diagram showing illustrative steps for orienting a user device display in accordance with some embodiments of the present disclosure;

FIG. 7B is a flow diagram showing illustrative steps for orienting a user device display in accordance with some embodiments of the present disclosure;

FIG. 8 is a flow diagram showing illustrative steps for reorienting a display of an uncoupled user device in accordance with some embodiments of the present disclosure;

FIG. 9 is a flow diagram showing illustrative steps for orienting a display of a user device based on stored criteria in accordance with some embodiments of the present disclosure;

FIG. 10 is a flow diagram showing illustrative steps for orienting a user device display based on an accessory type in accordance with some embodiments of the present disclosure;

FIG. 11 is a flow diagram showing illustrative steps for accessing available information for determining display orientation in accordance with some embodiments of the present disclosure;

FIG. 12 shows an illustrative arrangement of a user device docked to an accessory in accordance with some embodiments of the present disclosure;

FIG. 13 shows an illustrative arrangement of a user device coupled to an accessory and a host device in accordance with some embodiments of the present disclosure; and

FIG. 14 shows an illustrative arrangement of a user device coupled to an accessory, each configured to couple to other devices in accordance with some embodiments of the present disclosure.

### DETAILED DESCRIPTION

The present disclosure is directed towards methods and apparatus for orienting a user device display. A user device may include a display screen, which may display images, text, video, soft commands, or other graphics to a user. The orientation of the user device display may be managed according to criteria such as, for example, user preferences, predetermined display orientations, accelerometer output, supported communications protocols, information about an accessory, any other suitable criteria, or any combinations thereof.

A user device may be coupled (e.g., “docked”) to an accessory which may provide one or more functions. Functions may include, for example, charging, transferring data, synchronizing, mounting/affixing, any other suitable function, or any combination thereof. In some embodiments, a user device may be coupled to any suitable accessory using a wired cable with suitable connectors (e.g., bundled wire cable with a 30-pin connector). In some embodiments, different types of accessories may have different physical orientations, different propensities to change physical orientation, or both. For example, an accessory may have a stationary physical orientation (e.g., substantially unchanging physical orientation), a dynamic physical orientation (e.g., changing physical orientation), or an adjustable physical orientation (e.g., substantially unchanging physical orientation other than infrequent adjustments).

The display of a user device, when docked to any suitable accessory, may be oriented according to a type of the accessory. For example, a particular criterion may be used to orient a display of the user device depending upon the expected propensity of a user device to change physical orientation when coupled to an accessory of a particular type. In a further example, a particular criterion may be used to orient a display of the user device depending upon a user's preference information.

For example, a “stationary” accessory such as a tabletop sound system may be expected to remain in a particular physical orientation. In some embodiments, the display of a user device coupled to a stationary accessory may be oriented according to, for example, an accelerometer of the user device.

In a further example, a “dynamic” accessory may be expected to change physical orientation repeatedly or unexpectedly. In some embodiments, the display of a user device coupled to a dynamic accessory may be oriented according to, for example, user input rather than an accelerometer of the user device.

In a further example, an “adjustable” accessory may, for example, be expected to undergo changes in physical orientation when adjusted by a user, but otherwise remain in a substantially constant physical orientation. In some embodiments, the display of a user device coupled to a dynamic accessory may be oriented according to, for example, user input, an accelerometer of the user device, or both.

In some embodiments, a display orientation of a user device, when coupled to a particular accessory, may be determined based on the accessory type, the accessory identity, user selections, output of a user device accelerometer, communications protocols supported by the accessory (e.g., “lingos”), communications protocols supported by the user device (e.g., “lingos”), any other suitable information, or any combination thereof. In some embodiments, processing equipment of a user device, an accessory, any other suitable device, or any combination thereof, may determine the display orientation of a user device when coupled to the accessory. In some embodiments, suitable information may be stored in memory hardware of a user device, an accessory, any other suitable device, or any combination thereof, and may be accessed by the processing equipment.

In some embodiments, one or more criteria for orienting a user device display when the user device may be coupled to an accessory may be stored in memory hardware. A particular criteria, or combination thereof, may be selected from among the stored criteria, based on a type of the user device, a type of the accessory, user preference information, any other suitable information, or any combination thereof. A display orientation may be determined based on the selected criteria, and the display of the device may be oriented based on the determined display orientation.

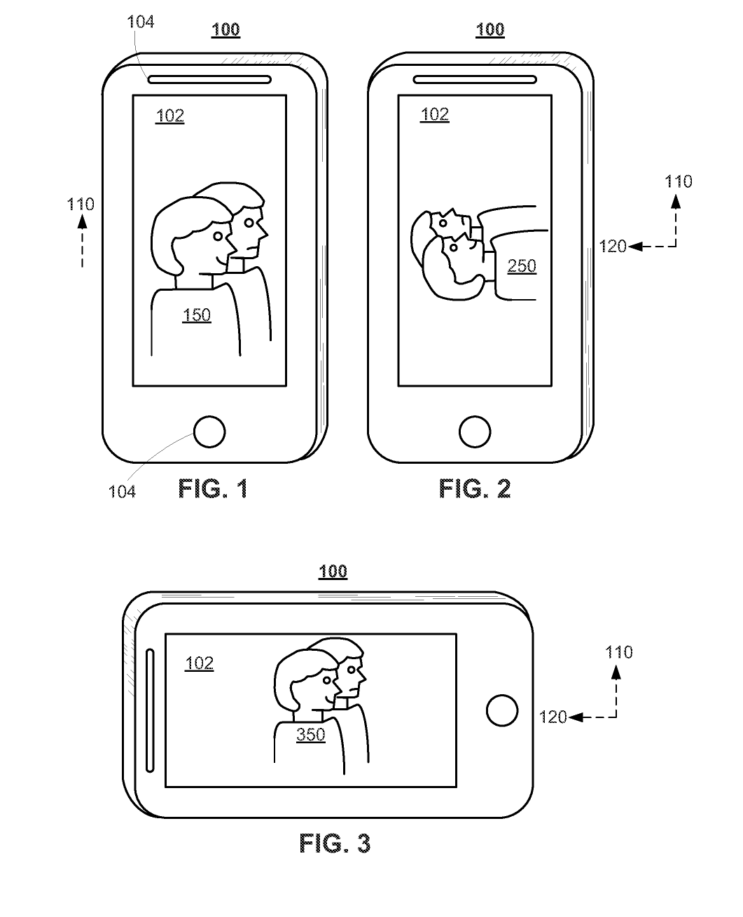

The present disclosure is described more fully in the context of FIGS. 1-14 below.

Shown in FIG. 1 is a front elevation view of illustrative user device 100 in accordance with some embodiments of the present invention. In some embodiments, user device 100 may include display screen 102, audio device 104 (e.g., a speaker), and hard command button 106. In some embodiments, user device 100 may include an energy storage device (e.g., a rechargeable battery), an accelerometer, processing equipment, memory, one or more input/output (I/O) interfaces, any other suitable components, or any combination thereof, which may be not shown in FIG. 1. In some embodiments, display screen 102 may be a touchscreen and may include, for example, one or more soft command buttons.

As shown in FIG. 1, user device 100 may be oriented along direction 110. Shown on display screen 102 of FIG. 1 is image 150 illustratively oriented also along direction 110. In some embodiments, direction 110 may represent the default user device orientation. For example, a user's vision may be oriented in direction 110 when the user is “face forward”. In some embodiments, direction 110 may be oriented substantially parallel with the force of gravity.

As shown in FIG. 2, user device 100 may be physically oriented along direction 110. Shown on display screen 102 of FIG. 2 is image 250 illustratively oriented along direction 120, which may be substantially normal to direction 110.

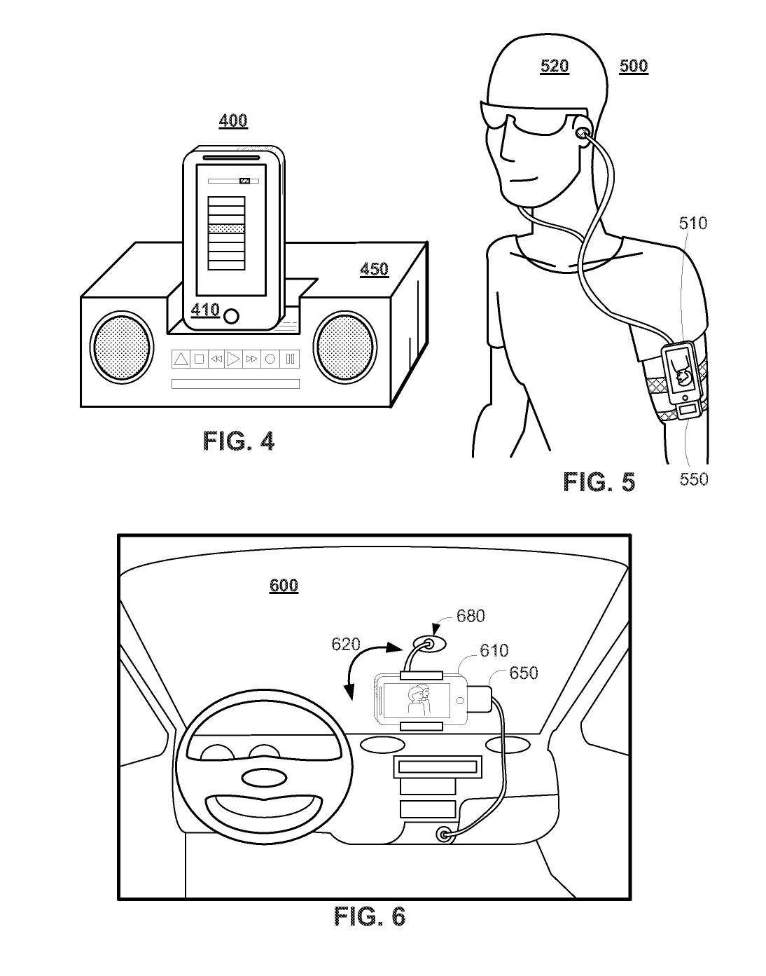

As shown in FIG. 3, user device 100 may be physically oriented along direction 120. Shown on display screen 102 of FIG. 3 is image 350 illustratively oriented also along direction 120.

It will be understood that direction 110 and 120 are merely illustrative, and are used to illustrate device and display screen orientations. In some embodiments, direction 110 may be arbitrary (e.g., not necessarily parallel to the force of gravity). In some embodiments, a particular user may prefer a particular display orientation (e.g., one of the orientations shown in FIGS. 1-3) relative to other display orientations. In some embodiments, a user may prefer to allow the display of display screen 102 be oriented by an accelerometer of user device 100. In some embodiments, a particular user may prefer a particular user device display orientations (e.g., one of the orientations shown in FIGS. 1-3) relative to other display orientations when the user device is coupled to a particular accessory. For example, a user may prefer particular display orientations depending upon the type of the accessory to which the user device is coupled. In some embodiments, a user may prefer that the display orientation be fixed relative to the physical orientation of a user device.

Shown in FIGS. 4-6 are three illustrative accessory types; a stationary accessory (i.e., stationary accessory 450), a dynamic accessory (i.e., dynamic accessory 550), and an adjustable accessory (i.e., adjustable accessory 650), respectively. It will be understood that the three types of accessories discussed below (e.g., stationary, dynamic, and adjustable) are illustrative, and that any suitable classification or distinction of an accessory type may be used in accordance with the present disclosure.

Shown in FIG. 4 is illustrative coupling arrangement 400 which includes user device 410 coupled (e.g., by a 30-pin plug and socket electrical connection) to stationary accessory 450. Stationary accessory 450 may be a speaker system, a video projection system, a computing device, a wall-mounted dock, any other suitable accessory which may have a substantially constant and primary physical orientation, or any combination thereof. For example, stationary accessory 450 may rest on a table top or other surface, and may have a constant physical orientation on that surface. In some embodiments, stationary accessory 450 need not be user portable.

In some embodiments, the display of user device 410, while coupled to stationary accessory 450, may be oriented vertically (i.e., upright). Because the physical orientation of user device 410 may be expected to remain unchanged while coupled to stationary accessory 450, the display orientation of user device 410 may remain constant relative to the physical orientation of user device 410. The physical orientation of user device 410 while coupled to stationary accessory 450 may be vertical, as illustratively shown in FIG. 4, or aligned in any other suitable direction. In some embodiments, the display orientation of user device 410, while coupled to stationary accessory 450, may be oriented vertically regardless of the physical orientation of user device 410.

Any suitable criteria, based on any suitable information, may be used to determine the display orientation of user device 410 when coupled to stationary accessory 450. For example, in some embodiments, user device 410 may include one or more accelerometers (e.g., a three-axis accelerometer arrangement), which may aid in orienting the display of user device 410 while coupled to stationary accessory 450. In some embodiments, user preference information may be used to orient the display of user device 410 while coupled to stationary accessory 450. For example, a user may specify that the display of user device 410 is to be oriented in a particular direction when user device 410 is coupled to stationary accessory 450. In some embodiments, identification information about stationary accessory 450 may be used to orient the display of user device 410 while coupled to stationary accessory 450. For example, the display orientation of user device 410 may based at least in part on a model number, serial number, manufacturer, supported communications protocol, or other suitable identification information of stationary accessory 450. In some embodiments, any suitable combination of information may be used to orient the display of user device 410. For example, output of an accelerometer along with user preferences may be used to orient the display of user device 410 while coupled to stationary accessory 450.

Shown in FIG. 5 is illustrative coupling arrangement 500 which includes user device 510 coupled (e.g., by a 30-pin plug and socket electrical connection) to dynamic accessory 550. Dynamic accessory 550 may be, for example, a user-wearable accessory (e.g., an exercise accessory), any other suitable accessory which may have a changing physical orientation, or any combination thereof. For example, dynamic accessory 550 may be an additional battery accessory coupled to user device 510 which may, along with user device 510, be worn by user 520 while exercising. Although shown in FIG. 5 as portable, dynamic accessory 550 need not be user portable.

In some embodiments, the display of user device 510, while coupled to dynamic accessory 550, may be, for example, oriented vertically but flipped relative to the upright direction (i.e., upside down). User 520 may prefer an upside down display orientation because user device may be mounted to user 520 as shown in FIG. 5, in which it may be more convenient for user 520 to see the display of user device 510. Although illustratively shown upside down in FIG. 5, the display of user device 510 may be oriented in any suitable direction. Because the physical orientation of user device 510 may be expected to change (e.g., moved during exercise) while coupled to dynamic accessory 550, the display orientation of user device 510 need not be based on an accelerometer. For example, the display orientation of user device 510 need not track the output of an accelerometer of user device 510 so as to avoid repeatedly changing the display orientation of user device 510 relative to the physical orientation of user device 510. In some embodiments, the display orientation of user device 510, while coupled to dynamic accessory 550, may be oriented vertically regardless of the physical orientation of user device 510, or changes thereof.

Any suitable criteria, based on any suitable information, may be used to determine the display orientation of user device 510 when coupled to dynamic accessory 550. For example, in some embodiments, user device 510 may include one or more accelerometers (e.g., a three-axis accelerometer arrangement), which may aid in orienting the display of user device 510 while coupled to dynamic accessory 550. In some embodiments, the display orientation of user device 510 may be determined independent of an accelerometer of user device 510. In some embodiments, user preference information may be used to orient the display of user device 510 while coupled to dynamic accessory 550. For example, a user may specify (e.g., provide a user gesture on a touch screen of user device 510) that the display of user device 510 is to be oriented in a particular direction when user device 510 is coupled to dynamic accessory 550. In some embodiments, identification information about dynamic accessory 550 may be used to orient the display of user device 510 while coupled to dynamic accessory 550. For example, the display orientation of user device 510 may based at least in part on a model number, serial number, manufacturer, supported communications protocol, or other suitable identification information of dynamic accessory 550. In some embodiments, any suitable combination of information may be used to orient the display of user device 510. For example, identification information along with user preferences may be used to orient the display of user device 510 while coupled to dynamic accessory 550.

Shown in FIG. 6 is illustrative coupling arrangement 600 which includes user device 610 coupled (e.g., by a 30-pin plug and socket electrical connection) to adjustable accessory 650. Adjustable accessory 650 may be, for example, a speaker system, a video projection system, a computing device, a wall-mounted dock, a car mounted accessory, a cable with suitable connectors, any other suitable accessory which may have an adjustable physical orientation, or any combination thereof. For example, dynamic accessory 650 may be a cabled charger plugged into a user device, whose orientation may be adjusted by a user. Adjustable accessory 650 may be, but need not be, user portable.

In some embodiments, the display of user device 610, while coupled to adjustable accessory 650, may be, for example, oriented vertically (i.e., upright). A user may prefer an upright display orientation, or any other suitable display orientation, in which it may be convenient for the user to see the display of user device 610. The physical orientation of user device 610 may be adjusted by a user (e.g., using an illustrative car-mounted fixture 680 as shown in FIG. 6), as shown by motion arrows 620, while coupled to adjustable accessory 650. The display orientation of user device 610 may be, but need not be, based on an accelerometer of user device 610. For example, the display orientation of user device 610 need not track the output of an accelerometer of user device 610 when a user adjusts the physical orientation of user device 610 using car-mounted fixture 680. In some embodiments, the display orientation of user device 610, while coupled to adjustable accessory 650, may be oriented vertically regardless of the physical orientation of user device 610, or changes thereof. In some embodiments, adjustable accessory 650 may be expected to change physical orientation less frequently relative to a dynamic accessory. In some embodiments, user device 610 may not undergo changes in physical orientation while coupled to adjustable accessory 650.

Any suitable criteria, based on any suitable information, may be used to determine the display orientation of user device 610 when coupled to adjustable accessory 650. For example, in some embodiments, user device 610 may include one or more accelerometers (e.g., a three-axis accelerometer arrangement), which may aid in orienting the display of user device 610 while coupled to adjustable accessory 650. In some embodiments, the display orientation of user device 610 may be determined independent of an accelerometer of user device 610. In some embodiments, user preference information may be used to orient the display of user device 610 while coupled to adjustable accessory 650. For example, a user may specify (e.g., select selectable options which may be stored in memory of user device 610) that the display of user device 610 is to be oriented in a particular orientation relative to the user device's physical orientation (e.g., portrait display, landscape display) when user device 610 is coupled to dynamic accessory 650. In some embodiments, identification information about adjustable accessory 650 may be used to orient the display of user device 610 while coupled to adjustable accessory 650. For example, the display orientation of user device 610 may based at least in part on a model number, serial number, manufacturer, supported communications protocol, or other suitable identification information of adjustable accessory 650. In some embodiments, any suitable combination of information may be used to orient the display of user device 610. For example, user preferences based on identification information about adjustable accessory 650 may be used to orient the display of user device 610 while coupled to adjustable accessory 650.

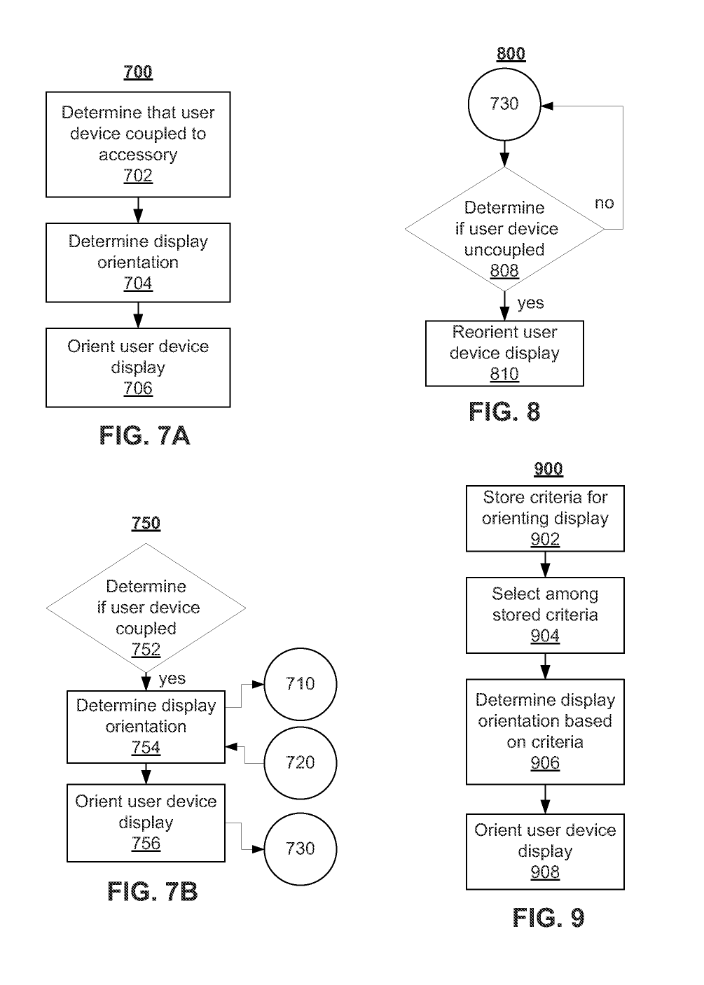

Illustrative techniques for orienting a display of a user device will be discussed in the context of FIGS. 7A-11 in accordance with some embodiments of the present disclosure. Any of the illustrative steps of flow diagrams 700-1100 of respective FIGS. 7A-11 may be combined with other steps, rearranged with other steps, omitted, appended with additional steps, or otherwise altered in accordance with the present disclosure.

FIG. 7A is flow diagram 700 showing illustrative steps for orienting a user device display in accordance with some embodiments of the present disclosure. The steps of flow diagram 700 may be performed by any suitable processing equipment which may be included in a user device, accessory, remote device (e.g., remote, processing facility, remote application server), any other suitable device, or any combination thereof.

Step 702 may include determining that a user device is coupled to an accessory. In some embodiments, step 702 may include receiving user input that a user device is coupled to an accessory, receiving information from the accessory, receiving information from the user device, any other indication that a user device is coupled to an accessory, or any combination thereof. For example, signals transmitted between a user device and a coupled accessory using an iPod Accessory Protocol (IAP) may indicate that the user device is coupled to the accessory.

In some embodiments, step 702 may include determining that one or more electrical terminals of a user device and corresponding electrical terminals of an accessory are in electrical contact. In some embodiments, one or more sensors may be included in the user device or the accessory, or both, to detect that the user device is coupled to the accessory. For example, a car-based user device charger may include a cable with one end plugged into a car cigarette lighter, and a 30-pin connector at the opposite end. When the 30-pin connector is plugged into a suitable user device, the user device may detect the coupling by detecting power at suitable terminals of the 30-pin plug arising from the car cigarette lighter.

In some embodiments, step 702 may include determining that a user device is coupled to an accessory by other than a wired connection, such as a wireless coupling (e.g., BLUETOOTH, WiFi), optical coupling (e.g., infrared, fiber optics), induction coupling (e.g., near-field communication (NFC)), any other suitable wireless coupling, or any combination thereof.

Step 704 may include determining a display orientation of a user device display. Step 704 may be performed in response to a determination that a user device is coupled to an accessory at step 702. In some embodiments, step 704 may include determining which criteria to use in orienting a display of a user device.

Step 706 may include orienting a display of a user device. In some embodiments, step 706 may be performed in response to determining a display orientation at step 704. In some embodiments, step 706 may include changing the display orientation of the user device to the determined display orientation of step 704. The display orientation of step 706 may be constant, or may change in time. For example, in some embodiments, the display orientation may be vertical and may remain constant. In a further example, the display orientation may be aligned with the user device's physical orientation and may remain fixed relative to the user device. In some embodiments, step 706 may include maintaining an initial display orientation (e.g., not changing the display orientation from that prior to coupling the user device to the accessory).

FIG. 7B is flow diagram 750 showing illustrative steps for orienting a user device display in accordance with some embodiments of the present disclosure. The steps of flow diagram 750 may be performed by any suitable processing equipment which may be included in a user device, accessory, remote device, any other suitable device, or any combination thereof.

Step 752 may include determining whether a user device is coupled to an accessory. In some embodiments, step 752 may include receiving user input that a user device is coupled to an accessory, receiving information from the accessory, receiving information from the user device, any other indication that a user device is coupled to an accessory, or any combination thereof. For example, signals transmitted between a user device and a coupled accessory using an IAP may indicate that the user device is coupled to the accessory.

In some embodiments, step 752 may include determining that one or more electrical terminals of a user device and corresponding electrical terminals of an accessory are in electrical contact. In some embodiments, one or more sensors may be included in the user device or the accessory, or both, to detect that the user device is coupled to the accessory.

In some embodiments, step 752 may include determining that a user device is coupled to an accessory by other than a wired connection, such as a wireless coupling, optical coupling, induction coupling, any other suitable wireless coupling, or any combination thereof.

Step 754 may include determining a display orientation of a user device display. Step 754 may be performed in response to a determination that a user device is coupled to an accessory at step 752. In some embodiments, step 754 may include determining which criteria to use in orienting a display of a user device.

In some embodiments, step 754 may include one or more of the steps of flowchart 1100 of FIG. 11, as shown by markers 710 and 720.

Step 756 may include orienting a display of a user device. In some embodiments, step 756 may be performed in response to determining a display orientation at step 754. In some embodiments, step 756 may include changing the display orientation of the user device to the determined display orientation of step 754. The display orientation of step 756 may be constant, or may change in time. For example, in some embodiments, the display orientation may be vertical and may remain constant. In a further example, the display orientation may be aligned with the user device's physical orientation and may remain fixed relative to the user device. In some embodiments, step 756 may include maintaining an initial display orientation.

In some embodiments, when the display has been oriented at step 756, any of the illustrative steps of flow diagram 800 of FIG. 8 may be performed, as shown by marker 730.

FIG. 8 is flow diagram 800 showing illustrative steps for reorienting a user device display when the user device is uncoupled from an accessory in accordance with some embodiments of the present disclosure. The steps of flow diagram 800 may be performed by any suitable processing equipment which may be included in a user device, accessory, remote device (e.g., remote, processing facility, remote application server), any other suitable device, or any combination thereof. In some embodiments, the illustrative steps of flow diagram 800 may be performed in conjunction with steps of flow diagram 750 of FIG. 7B.

Step 808 may include determining whether a user device is uncoupled with an accessory (e.g., the user device and accessory of flow diagram 750 of FIG. 7B as shown by marker 730). In some embodiments, step 808 may include receiving user input that a user device is or is about to be communicatively uncoupled from an accessory, receiving information from the accessory, receiving information from the user device, any other indication that a user device is communicatively uncoupled to an accessory, or any combination thereof. In some embodiments, a lack of a particular signal or sensor output may indicate that the user device has become uncoupled from the accessory. In some embodiments, if it is determined that the user device is not uncoupled from (i.e., still coupled to) the accessory, the user device display may continue to be oriented according to the current orientation.

In some embodiments, step 808 may include determining that one or more electrical terminals of a user device and corresponding electrical terminals of an accessory are not in electrical contact. In some embodiments, one or more sensors may be included in the user device or the accessory, or both, to detect that the user device is communicatively uncoupled from the accessory. In some embodiments, a time lag may be used to determine whether the user device has become uncoupled from the accessory, in which if the user device has been uncoupled for more than a time threshold (e.g., 1 minute, or other threshold), a determination may be made that the user device is uncoupled from the accessory.

Step 810 may include reorienting the display of the user device. Step 810 may, but need not, include changing the display orientation of the user device. In some embodiments, step 810 may be performed in response to determining that a user device has become uncoupled from an accessory at step 808. In some embodiments, step 810 may include using a different criterion than before the user device was uncoupled in determining a display orientation for the user device display. For example, if the user device is determined to be uncoupled from the accessory, the display orientation of the user device may return to the previous user setting.

In an illustrative example, processing circuitry of a user device may determine that the user device is coupled to a particular accessory at step 752. The processing circuitry may determine a display orientation based on available information about the particular accessory at step 754, and orient the display at step 756. The processing circuitry may determine that the user device has become uncoupled from accessory (e.g., due to user action, accident, malfunction) at step 808. The display orientation of the user device may then be reoriented based on suitable criteria such as the criteria used previous to being coupled to the accessory at step 810.

FIG. 9 is flow diagram 900 showing illustrative steps for orienting a display of a user device based on stored criteria in accordance with some embodiments of the present disclosure. The steps of flow diagram 900 may be performed by any suitable processing equipment which may be included in a user device, accessory, remote device (e.g., remote, processing facility, remote application server), any other suitable device, or any combination thereof.

Step 902 may include storing criteria for orienting a display of a user device. In some embodiments, step 902 may include receiving and storing user input (e.g., to a keyboard, touchscreen or other user input interface), storing predetermined display criteria, any suitable actions for storing criteria, or any combination thereof. Step 902 may include storing criteria in any suitable memory such as, for example, flash memory, a hard disk, a compact disk, a floppy disk, any other suitable memory, or any combination thereof. Criteria may be stored in memory which may be included in any suitable device such as the user device, an accessory, removable memory hardware (e.g., a USB flash drive), local computing device, remote server, any other suitable device, or any combination thereof. In some embodiments, step 902 may include encrypting, distributing (e.g., cloud storage of data), indexing, cataloguing, or otherwise managing data storage in one or more memory storage devices.

In some embodiments, stored criteria may include a set of one or more conditions for determining a display orientation of a user device. For example, stored criteria may include instructions whether to use an accelerometer of a user device when coupled to a particular accessory, user preferences for a particular accessory, any other suitable criteria, or any combinations thereof. In some embodiments, stored criteria may include a set of nested conditions for determining a display orientation of a user device. In some embodiments, stored criteria may include different criteria for different types of accessories. For example, when not coupled to any accessory, a user device with a display screen may use a particular criterion (e.g., a user input via touchscreen gesture, user device accelerometer) to orient the display screen display. When the user device is coupled to an accessory, the user device may use the same or a different criterion (e.g., based on accessory type, based on user preference) to orient the display.

Step 904 may include selecting criteria from among stored criteria. In some embodiments, step 904 may include receiving user input to a suitable user input interface, selecting one or more criteria. In some embodiments, step 904 may include suitable processing equipment selecting one or more criteria from among a plurality of stored criteria. In some embodiments, step 904 may include accessing a database, recalling one or more database entries, performing logic operations, any other suitable action for selecting one or more criteria, or any combination thereof.

For example, in some embodiments, a user may select a criterion from a pull-down menu, displayed by a user device, which may include a plurality of criteria. In a further example, processing circuitry of the user device may determine that the user device is coupled to a stationary accessory, and may select a criterion consistent with a stationary accessory.

In some embodiments, step 904 may include one or more of the illustrative steps of flowchart 1100 of FIG. 11.

Step 906 may include determining a display orientation based on selected criteria. In some embodiments, step 906 may include determining that a fixed display orientation is to be used. For example, it may be determined at step 906 that the display orientation should be vertical based on the selected criteria. In some embodiments, step 906 may include determining that a conditional display orientation is to be used. For example, it may be determined at step 906 that the display orientation should be conditioned to track the output of an accelerometer of the user device based on the selected criteria.

Step 908 may include orienting a display of a user device based on a determined display orientation. In some embodiments, step 908 may be performed in response to determining a display orientation at step 906. In some embodiments, step 908 may include changing the display orientation of the user device to the determined display orientation of step 906. The display orientation of step 908 may be temporally constant, or may change in time. For example, in some embodiments, the display orientation may be horizontal and may remain constant. In a further example, the display orientation may be aligned with the user device's physical orientation and may remain constant relative to the user device.

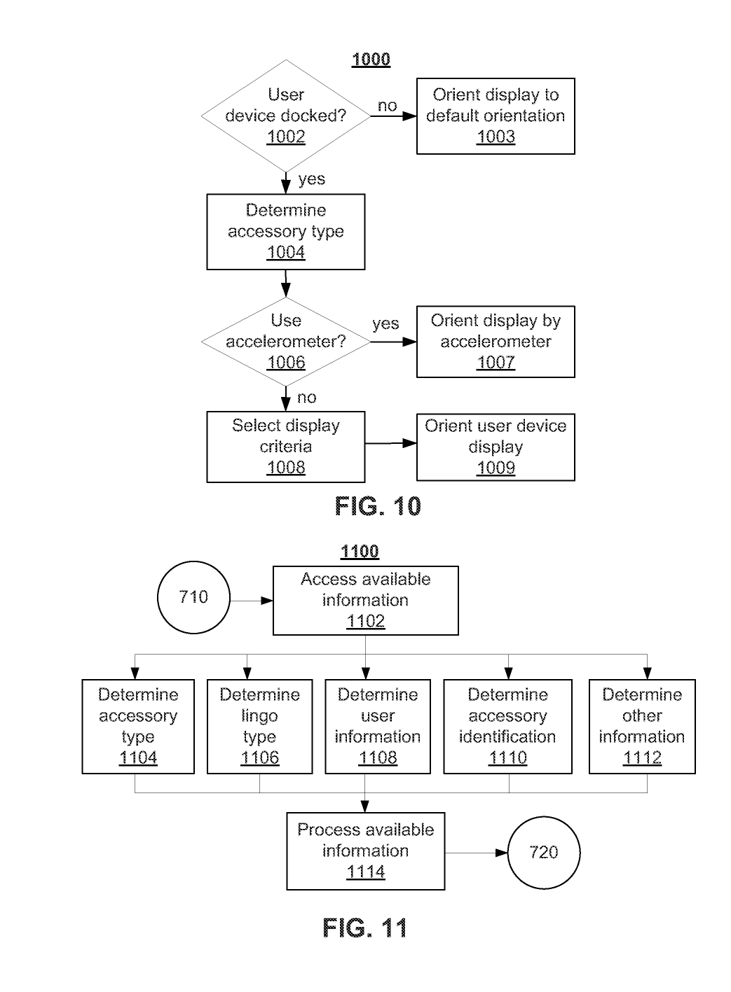

FIG. 10 is flow diagram 1000 showing illustrative steps for orienting a user device display based on an accessory type in accordance with some embodiments of the present disclosure. The steps of flow diagram 1000 may be performed by any suitable processing equipment which may be included in a user device, accessory, remote device (e.g., remote, processing facility, remote application server), any other suitable device, or any combination thereof.

Step 1002 may include determining whether a user device is coupled to an accessory. In some embodiments, step 1002 may include receiving user input that a user device is coupled to an accessory, receiving information from the accessory, receiving information from the user device, any other indication that a user device is coupled to an accessory, or any combination thereof. For example, signals transmitted between a user device and a coupled accessory using an IAP may indicate that the user device is coupled to the accessory.

At step 1002, it may be determined that a user device is not coupled to an accessory. In response to determining that the user device is not coupled to the accessory, the display of the user device may be oriented according to a default orientation, as shown by step 1003. The default orientation may be user defined, a particular direction relative to the ground (e.g., parallel to the force of gravity), a particular direction relative to the physical orientation of the user device (e.g., portrait, landscape), any other suitable orientation, or any combination thereof. In some embodiments, step 1003 may include maintaining an initial display orientation (e.g., not changing the display orientation from that prior to the determination of step 1002).

At step 1002, it may be determined that a user device is coupled to an accessory. In response to determining that the user device is coupled to the accessory, a type of the accessory may be determined, as shown by step 1004. The type of the accessory may include stationary, dynamic, adjustable, or any other suitable accessory type designation, or any combinations thereof. In some embodiments, step 1004 may include accessing available information as shown by the illustrative steps of flow diagram 1100 of FIG. 11. For example, step 1004 may include accessing accessory identification information such as model number in order to determine the type of accessory.

Step 1006 may include determining whether to use an accelerometer of the user device to orient the display of the user device. In some embodiments, the determination of step 1006 may be, but need not be, based on the type of the accessory to which the user device is coupled.

At step 1006, it may be determined that an accelerometer of the user device is to aid in orienting the display, as shown by step 1007. In some embodiments, step 1007 may include determining to dampen the effect of the accelerometer. For example, in some embodiments, it may be determined at step 1004 that the accessory is a dynamic accessory, and at step 1006 that a user's preference is to orient the display according to output of an accelerometer of the user device. In some embodiments, it may also be determined to average (e.g., time average, moving average) the output of the accelerometer such that frequent movement does not cause frequent reorientation of the display.

At step 1006, it may be determined that the display of the user device is not to be oriented based on output of an accelerometer (e.g., the user device does not include an accelerometer). For example, it may be determined at step 1004 that the accessory is a dynamic accessory, and that a user's preference is not to orient the display according to output of an accelerometer of the user device.

Step 1008 may include selecting one or more display criteria. In some embodiments, step 1008 may be performed if the display is not to be oriented based on output of an accelerometer of the user device. In some embodiments, step 1008 may include any of the illustrative steps of flow diagram 900 of FIG. 9 for selecting among a plurality of stored criteria. The user device display may be oriented at step 1009 based on the selected criteria from step 1008. In some embodiments, step 1009 may include maintaining an initial display orientation (e.g., not changing the display orientation from that prior to coupling the user device to the accessory).

FIG. 11 is flow diagram 1100 showing illustrative steps for accessing available information in accordance with some embodiments of the present disclosure. The steps of flow diagram 1100 may be performed by any suitable processing equipment which may be included in a user device, accessory, remote device (e.g., remote, processing facility, remote application server), any other suitable device, or any combination thereof. In some embodiments, the illustrative step of flow diagram 1100 may be performed in conjunction with the illustrative steps of flow diagram 750 of FIG. 7B via markers 710 and 720.

Step 1102 may include accessing information that may be available in regards to orienting the display of a user device. Step 1102 may include accessing information stored in the user device, in an accessory to which the user device may be coupled, in a remote memory storage device or facility, any other suitable memory, or any combination thereof. In some embodiments, step 1102 may include requesting data from the user device, the accessory, or both. In some embodiments, step 1102 may include transferring data between the user device and the accessory (e.g., using an IAP).

Step 1104 may include determining a type of the accessory. In some embodiments, the type of the accessory may include one or more accessory designations which may indicate accessory functionality (e.g., audio, charging, data transfer), propensity to change physical orientation (e.g., stationary, dynamic, adjustable), a user designation (e.g., “Mike's stereo”), any other suitable designation, or any combination thereof.

Step 1106 may include determining a type of lingo supported by a user device or accessory. In some embodiments, the type of lingo may include speaker, microphone, remote, any other suitable supported protocol, or any combination thereof. Supported lingos of an accessory may be communicated (e.g., using IAP) to suitable processing equipment when a user device is coupled to an accessory. For example, suitable processing equipment may determine that only a simple remote lingo is support by an accessory, and that the accessory is likely a stationary accessory.

Step 1108 may include determining user information. User information may include user preferences (e.g., user selected options), user identity information (e.g., user profile information), user device display history for a particular user, user input received at a suitable user input interface, any other suitable user information, or any combination thereof. For example, in some embodiments, user information may include a user two-finger gesture specifying a display orientation received at a touchscreen of a user device. In a further example, user information may include a user profile, inputted by a user using a user interface (e.g., keyboard, mouse), which may specify the user's preferences.

Step 1110 may include determining accessory identification information. Accessory identification information may include a model number, serial number, manufacturer, user supplied identification (e.g., “Mike's car charger 1”), any other suitable identification information, or any combination thereof. In some embodiments, identification information about an accessory may be provided by one or more circuit elements (e.g., a resistor, a bank of resistors) whose properties may be catalogued.

Step 1112 may include determining any suitable information other than information referenced at steps 1104-1110. Other information may include information about the user device, information about the communicative coupling between the user device and an accessory, statistical information about a plurality of users (e.g., the most popular display orientation for a particular user device coupled to a particular accessory), manufacturer supplied information (e.g., an intended display orientation), any other suitable information, or any combination thereof. In some embodiments, no information may be available about an accessory to which a user device may be coupled. If no information is available, step 1112 may include querying a user, manufacturer, database, any other suitable resource, or combinations thereof, to gather information.

Any or all of steps 1104-1112 may be performed as available information is accessed. In some embodiments, combinations of steps 1104-1112 may be performed. For example, accessory identification information may be accessed (e.g., at step 1110), which may indicate or suggest an accessory type (e.g., at step 1104). In a further example, a lingo type may be determined (e.g., at step 1106) which may indicate or suggest a type of accessory (e.g., at step 1104), and a user profile may indicate the user's preference for that type of accessory (e.g., at step 1108). In a further example, the identification of a user device may be determined (e.g., at step 1112), the identification of the accessory may be determined (e.g., at step 1110), and user device information such as a user profile may indicate the user's display orientation preference for the particular user device coupled to the particular accessory.

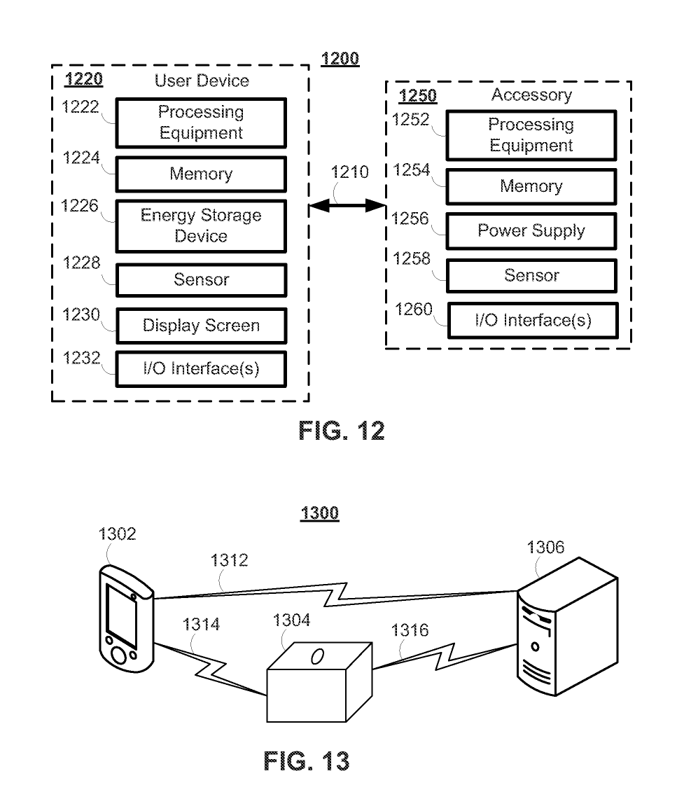

Shown in FIG. 12 is illustrative arrangement 1200 of user device 1220 coupled to accessory 1250 via coupling 1210 in accordance with some embodiments of the present disclosure. User device 1220 may include processing equipment 1222, memory 1224, energy storage device 1226, sensor 1228, display screen 1230, I/O interface 1232, any other suitable components, subsystems or devices, or any suitable combination thereof.

In some embodiments, user device 1220 may be coupled to processing equipment 1252, memory 1254, power supply 1256, sensor 1258, I/O interface 1260, any other suitable component, or any combination thereof which may be included as part of accessory 1250 via coupling 1210. Coupling 1210 may, for example, include couplings for data transfer, charging, diagnostics, accessories, any other suitable types of couplings, or any combination thereof. In some embodiments, an accessory may be coupled to, but need not include, processing equipment 1252, memory 1254, power supply 1256, sensor 1258, or I/O interface 1260. For example, accessory 1250 may include a suitable collection of electrical terminals which may interface with electrical terminals of user device 1220, and accessory 1250 may be coupled via USB cable to an external device such as a computer.

In some embodiments, user device 1220 may include processing equipment 1222 which may include a central processing unit (CPU) (e.g., microprocessor), collection of processors (e.g., parallel processors), CPU cache, random access memory (RAM), I/O communications interfaces, suitable circuitry, any other suitable processing elements or any combination thereof.

In some embodiments, user device 1220 may include memory 1224 which may be a hard drive, flash memory drive, MMC, SD card, SIM card, any other suitable memory device, or combination thereof.

In some embodiments, user device 1220 may include energy storage device 1226. Energy storage device 1226 may include, for example, a primary battery, a secondary battery (e.g., a lithium-ion battery), a super capacitor, any other suitable component which may store energy, or any combination thereof.

In some embodiments, user device 1220 may include sensor 1228. Sensor 1228 may include any suitable type of sensor, circuit, device, component, or combinations thereof which may be used to indicate whether user device 1220 is coupled to accessory 1250. For example, sensor 1228 may be coupled to one or more communication terminals of user device 1220, which may transmit a signal when user device 1220 is coupled to accessory 1250. In a further example, sensor 1228 may include one or more accelerometers, which may indicate to processing equipment 1222 the proper acceleration of user device 1220 in one or more directions.

In some embodiments, user device 1220 may include display screen 1230. Display screen 1230 may be any suitable type of display screen such as, for example, a liquid crystal display (LCD), a light emitting diode display (LED), a plasma display, a cathode ray tube display (CRT), an electrophoretic display, any other suitable type of display screen, or any combination thereof.

In some embodiments, user device 1220 may include I/O interface 1232. For example, I/O interface 1232 may allow user device 1220 to communicate with any type of device, component or network including an audio device, memory device, user input device, personal communication device, computer, wired network, wireless network, any other suitable device or network, or any combination thereof. For example, I/O interface 1232 may include a user input interface which may include a touchscreen, touchpad, trackball, mouse, keyboard, speaker, microphone, camera, any other suitable components or features, or any combination thereof. In a further example, I/O interface 1232 may include one or more Ethernet ports, wireless transmitters, wireless receivers, any other suitable interfaces, any suitable interface hardware, any suitable interface software, or any combination thereof.

In some embodiments, accessory 1250 may, but need not, include processing equipment 1252 which may include a central processing unit (CPU) (e.g., microprocessor), collection of processors (e.g., parallel processors), CPU cache, random access memory (RAM), I/O communications interfaces, suitable circuitry, any other suitable processing elements or any combination thereof.

In some embodiments, accessory 1250 may, but need not, include memory 1254 which may be a hard drive, flash memory drive, MMC, SD card, SIM card, any other suitable memory device, or combination thereof.

In some embodiments, accessory 1250 may, but need not, include power supply 1256. Power supply 1256 may include, for example, an alternating current (AC) power supply (e.g., a wall socket), a direct current (DC) power supply, a transformer, a primary battery, a secondary battery, any other suitable component which may store energy, or any combination thereof. In some embodiments, coupling 1210 may include an inductive coupling for charging energy storage device 1226 using power supply 1256.

In some embodiments, accessory 1250 may include sensor 1258. Sensor 1258 may include any suitable type of sensor, circuit, device, component, or combinations thereof which may be used to indicate whether user device 1220 is coupled to accessory 1250. For example, sensor 1228 may be coupled to one or more communication terminals of accessory 1250, which may transmit a signal when user device 1220 is coupled to accessory 1250. In a further example, sensor 1258 may include one or more accelerometers, which may indicate to processing equipment 1252 the proper acceleration of accessory 1250 in one or more directions.

In some embodiments, accessory 1250 may include I/O interface 1260. For example, I/O interface 1260 may allow accessory 1250 to communicate with any type of device, component or network including an audio device, memory device, user input device, personal communication device, computer, wired network, wireless network, any other suitable device or network, or any combination thereof.

Shown in FIG. 13 is illustrative arrangement 1300 of user device 1302 coupled to accessory 1304 via coupling 1314 and external device 1306 via coupling 1312, and coupling 1316 which may couple accessory 1304 to external device 1306 in accordance with some embodiments of the present disclosure. Any of couplings 1312, 1314, and 1316 may be any suitable type of wired coupling (e.g., 30-pin connection, Ethernet connection), wireless coupling (e.g., WiFi, BLUETOOTH), optical coupling, induction coupling, any other suitable type communicative coupling, any suitable communication interfaces, or any combination thereof. In some embodiments, couplings 1312, 1314, and 1316 may be formed by connecting (e.g., plugging) corresponding connectors of user device 1302, accessory 1304, or external device 1306.

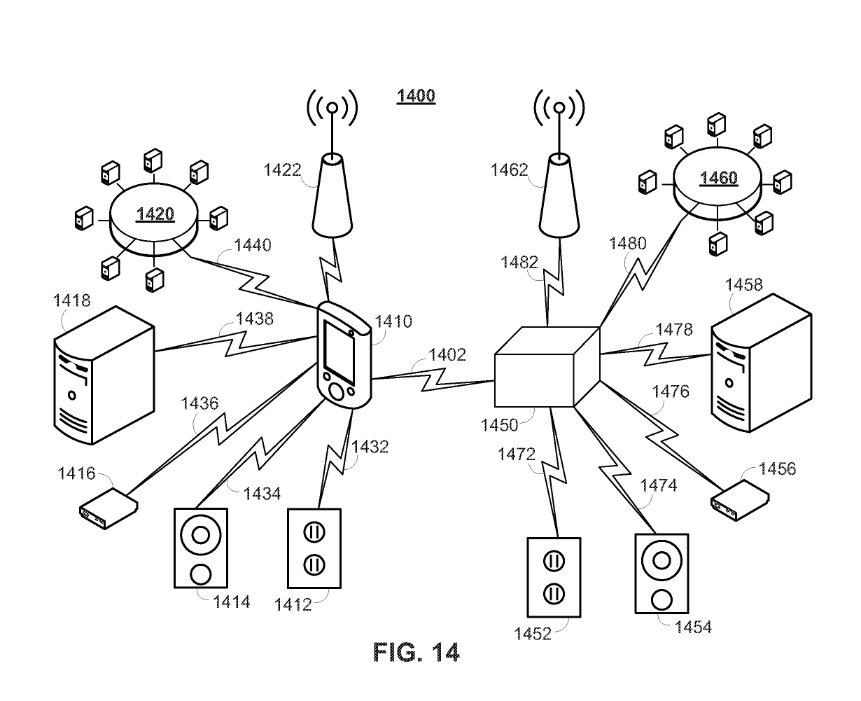

Shown in FIG. 14 is illustrative arrangement 1400 of user device 1410 coupled to accessory 1450 via coupling 1440, each configured to couple to other devices in accordance with some embodiments of the present disclosure.

In some embodiments, user device 1410 may be configured to couple to power supply 1412 via power coupling 1432, audio device 1414 via coupling 1434, memory 1416 via coupling 1436, external device 1418 via coupling 1438, network 1420 via coupling 1402, wireless network 1422 via coupling 1442, any other suitable devices, components, or networks, or any combination thereof.

For example, user device 1410 may be configured to couple to power supply 1412, which may be a wall socket, via coupling 1432 which may be a bundled cable with a wall plug and AC-DC transformer. In a further example, user device 1410 may be configured to couple to power supply 1412 which may be a power supply included in a computer via coupling 1432 which may be a USB cable with suitable 4-pin connector plugs. In a further example, user device 1410 may be configured to couple to audio device 1412 which may be a table top speaker system via coupling 1434 which may be a 30-pin rigid connection. In a further example, user device 1410 may be configured to couple to memory 1416 which may be a USB flash memory drive via coupling 1436 which may be a plug-in USB connection. In a further example, user device 1410 may be configured to couple to external device 1418 which may be a computer via coupling 1438 which may include a cable and plug-in USB connectors. In a further example, user device 1410 may be configured to couple to network 1420 which may be a local area network (LAN) via coupling 1440 which may include an ethernet cable and suitable plug-in 8P8C connectors. In a further example, user device 1410 may be configured to couple to wireless network 1422 which may be a wireless LAN via coupling 1442 which may allow signals to be transferred between a wireless transmitter and receiver.

In some embodiments, accessory 1450 may be configured to couple to power supply 1452 via coupling 1472, audio device 1454 via coupling 1474, memory 1456 via coupling 1476, external device 1458 via coupling 1478, network 1460 via coupling 1480, wireless network 1462 via coupling 1482, any other suitable devices, components, or networks, or any combination thereof.

For example, accessory 1450 may be configured to couple to power supply 1452 which may be a wall socket via coupling 1472 which may be a bundled cable with a wall plug and AC-DC transformer. In a further example, accessory 1450 may be configured to couple to power supply 1452 which may be a power supply included in a computer via coupling 1472 which may be a USB cable with suitable 4-pin connector plugs. In a further example, accessory 1450 may be configured to couple to audio device 1452 which may be one or more speakers via coupling 1474 which may include a cable and one or more tip-ring-sleeve (TRS) connectors. In a further example, accessory 1450 may be configured to couple to memory 1456 which may be a hard disk drive via coupling 1476 which may include a cable with one or more plug-in USB connectors. In a further example, accessory 1450 may be configured to couple to external device 1458 which may be a computer via coupling 1478 which may include a cable with one or more plug-in USB connectors. In a further example, accessory 1450 may be configured to couple to network 1460 which may be a wide area network (WAN) via coupling 1480 which may include an ethernet cable and suitable plug-in 8P8C connectors. In a further example, accessory 1450 may be configured to couple to wireless network 1462 which may be a WiFi network via coupling 1482 which may allow signals to be transferred between a wireless transmitter and receiver.

Although shown illustratively as separate devices in FIG. 14, in some embodiments, power supply 1412 and 1452, audio device 1414 and 1454, memory 1416 and 1456, and external device 1418 and 1458 may be the same or different devices, respectively. For example, as illustratively shown in FIG. 13, a user device may be coupled to both an accessory and an external device, which may in turn be coupled to one another. In some embodiments, network 1420 and 1460 may be the same or different networks, and if different may be coupled with one another. In some embodiments, wireless network 1422 and 1462 may be the same or different networks, and if different may be coupled with one another.

It will be understood that various directional and orientational terms such as “horizontal” and “vertical,” “top” and “bottom” and “side,” “length” and “width” and “height” and “thickness,” “inner” and “outer,” “internal” and “external,” and the like are used herein only for convenience, and that no fixed or absolute directional or orientational limitations are intended by the use of these words. For example, the components and elements of this disclosure may have any desired orientation. If reoriented, different directional or orientational terms may need to be used in their description, but that will not alter their fundamental nature as within the scope and spirit of this disclosure.

It will also be understood that the previously discussed embodiments and examples are only illustrative of aspects of the disclosed coupling arrangements, and are not presented for purposes of limitation. It will be understood that various techniques for orienting a user device display may be made available to the user and examples included herein are solely for convenience. Those skilled in the art will appreciate that the disclosed display orientations may be practiced by other than the described embodiments, and the disclosure is limited only by the claims that follow.

What is claimed is:

1. A method for orienting a display on a display screen of a user device, the method comprising:
determining using processing equipment that the user device is coupled to an accessory;
determining using the processing equipment a display orientation based at least in part on information about the accessory; and
orienting the display according to the determined display orientation.

2. The method of claim 1, wherein orienting the display according to the determined display orientation further comprises maintaining an initial display orientation.

3. The method of claim 1, wherein the information about the accessory comprises a type of the accessory.

4. The method of claim 3, wherein the type of the accessory is selected from the group consisting of a stationary accessory, a dynamic accessory, an adjustable accessory, or any combination thereof.

5. The method of claim 1, wherein the information about the accessory comprises identification information of the accessory.

6. The method of claim 5, where the identification information of the accessory comprises information selected from the group consisting of a serial number, a model number, a manufacturer, an accessory communication protocol, or any combination thereof.

7. The method of claim 1, wherein determining the display orientation is further based at least in part on user preference information.

8. The method of claim 1, wherein the determining the display orientation based at least in part on the information about the accessory comprises determining the display orientation based at least in part on the information about the accessory stored in memory of the accessory.

9. The method of claim 1, wherein the determining the display orientation is further based at least in part on output of an accelerometer of the user device.

10. The method of claim 1, wherein the determining the display orientation is further based at least in part on a touch gesture provided by a user to the display screen of the user device.

11. The method of claim 1, further comprising:
determining that the user device has become uncoupled with the accessory; and
reorienting the display according to a default display orientation.

12. A method for managing a display orientation of a display of a user device display screen, the method comprising:
storing a plurality of criteria for use in determining a display orientation;
selecting at least one of the criteria;
determining a display orientation based on the selected criteria;
orienting the display based at least in part on the determined display orientation.

13. The method of claim 12, wherein orienting the display further comprises maintaining an initial display orientation.

14. The method of claim 12, wherein the plurality of criteria comprises a type of an accessory to which the user device is coupled.

15. The method of claim 14, wherein the type of the accessory is selected from the group consisting of a stationary accessory, a dynamic accessory, an adjustable accessory, or any combination thereof.

16. The method of claim 12, wherein the plurality of criteria comprises a touch gesture provided by a user to the user device display screen.

17. The method of claim 12, further comprising selecting a default criteria, and wherein determining the display orientation based on the selected criteria further comprises determining the display orientation based on the default criteria.

18. A user device comprising:
a display screen configured to provide a display; and
processing equipment configured to:
determine that the user device is coupled to an accessory;
determine a display orientation based at least in part on information about the accessory; and
orient the display based on the determined display orientation.

19. The user device of claim 18, further comprising an accelerometer configured to sense the acceleration of the user device, wherein the processing equipment is further configured to:
communicate with the accelerometer; and
determine the display orientation further based at least in part on the sensed acceleration.

20. The user device of claim 19, wherein the determining the display orientation further based at least in part on the sensed acceleration comprises applying a signal processing technique to smooth output communicated by the accelerometer.

21. The user device of claim 18, further comprising a user interface, wherein the user interface is configured to receive input from a user.

22. The user device of claim 18, further comprising memory hardware, wherein the memory hardware is configured to store at least some of the information about the accessory.
